(19) United States
(12) Patent Application Publication
(10) Pub. No.: US 2022/0281599 A1
(43) Pub. Date: Sep. 8, 2022

(54) UNMANNED AERIAL VEHICLE AND CONTROL METHOD THEREOF

(71) Applicant: Shanghai Autoflight Co., Ltd., Shanghai (CN)

(72) Inventor: Yu Tian, Hong Kong SAR (CN)

(21) Appl. No.: 17/194,333

(22) Filed: Mar. 8, 2021

(51) Int. Cl. B64C 39/02; G05D 1/08

(52) U.S. Cl. CPC B64C 39/024; G05D 1/0808; B64C 2201/108; B64C 2201/042

(57) ABSTRACT

The present invention discloses an unmanned aerial vehicle and a control method thereof. The unmanned aerial vehicle includes a control module, motor arms, a plurality of lift motors and lift propellers. The control module is used to preset a correspondence between two ends of each motor arm and the corresponding lift motors; the control module is used to control each lift motor to be initiated; the control module is also used to determine whether a lift motor fails, determine a target lift motor and a target position if so, and adjust the power of other lift motors in all the lift motors corresponding to the target position apart from the target lift motor. The present invention improves the flight stability and safety of the unmanned aerial vehicle.

### TECHNICAL FIELD

The present invention relates to the technical field of automatic control, in particular to an unmanned aerial vehicle and a control method thereof.

### BACKGROUND

With the rapid development of technologies, the unmanned aerial vehicle industry are also rapidly developed, and demands for unmanned aerial vehicles and the application fields of the unmanned aerial vehicles have also been continuously developed. However, existing unmanned aerial vehicles have the problem of relatively low flight performance. For example, if a lift motor fails during the cruise of an unmanned aerial vehicle, it is easy to cause unstable flight of the unmanned aerial vehicle or even crash and damage of the entire aerial vehicle; in case of insufficient power drive, or if a power drive mechanism fails, it is easy to cause the whole unmanned aerial vehicle to lose power and cause accidents. Therefore, the stability, the safety and the like of the existing unmanned aerial vehicle cannot be effectively ensured.

### SUMMARY

The technical problem to be solved by the present invention is to overcome the defects, in the existing technology, that an unmanned aerial vehicle is relatively low in flight performance, and the stability and the safety cannot be effectively ensured. An unmanned aerial vehicle and a control method thereof are provided.

The present invention solves the above technical problems through the following technical solutions:

The present invention provides an unmanned aerial vehicle. The unmanned aerial vehicle includes a control module, motor arms, a plurality of lift motors and lift propellers.

The control module is provided in a fuselage main body of the unmanned aerial vehicle.

The motor arms are fixedly provided on two sides of the fuselage main body in parallel respectively.

The lift motors are electrically connected with the control module.

Two ends of the motor arms are respectively provided with at least two of the lift motors.

The lift motors are provided in the motor arms, and the lift propellers are fixedly provided on the motor arms.

One lift motor is fixedly connected with at least one lift propeller.

The control module is used to preset a correspondence between two ends of each motor arm and the corresponding lift motors.

The control module is used to control each lift motor to be initiated to drive the corresponding lift propeller to rotate to work.

the control module is also used to determine whether a lift motor fails, determine that the failing lift motor is a target lift motor if so, acquire, according to the correspondence, a target position on the motor arm corresponding to the target lift motor, and adjust the power of other lift motors in all the lift motors corresponding to the target position apart from the target lift motor.

Preferably, the unmanned aerial vehicle further includes at least two first steering engines and second steering engines.

The first steering engines are fixedly provided in a left wing of the unmanned aerial vehicle, and the second steering engines are fixedly provided in a right wing of the unmanned aerial vehicle.

Each first steering engine is fixedly connected with one first control surface on the left wing, and each second steering engine is fixedly connected with one second control surface on the right wing.

The control module is electrically connected with the first steering engines and the second steering engines respectively.

The control module is used to control the first steering engines and the second steering engines to adjust the deflecting directions of the first control surfaces and the second control surfaces.

Preferably, when the left wing includes two first steering engines, the first steering engines include a first sub steering engine and a second sub steering engine, and the second sub steering engine is located on the outer side of the first sub steering engine.

When the left wing includes two second steering engines, the second steering engines include a third sub steering engine and a fourth sub steering engine, and the fourth sub steering engine is located on the outer side of the third sub steering engine.

The control module is used to control the deflecting directions of both the first control surface corresponding to the first sub steering engine and the second control surface corresponding to the third sub steering engine to be upward, and control the deflecting directions of both the first control surface corresponding to the second sub steering engine and the second control surface corresponding to the fourth sub steering engine to be downward.

Preferably, when the two first steering engines are provided in the left wing, and the two second steering engines are provided in the right wing, the control module is used to control the deflecting directions corresponding to the two first control surfaces of the left wing to be opposite, and control the deflecting directions corresponding to the two second control surfaces of the right wing to be opposite; or, the control module is used to control the deflecting directions of the two first steering engines and the two second steering engines to be consistent.

Preferably, the unmanned aerial vehicle further includes a first drive motor, a second drive motor, a first drive propeller and a second drive propeller.

Both the first drive motor and the second drive motor are provided in the fuselage main body, and are fixedly provided at the front end and the rear end of the fuselage main body respectively.

The first drive propeller is electrically connected with the first drive motor, and the first drive propeller is fixedly provided at the front end of the fuselage main body.

The second drive propeller is electrically connected with the second drive motor, and the second drive propeller is fixedly provided at the rear end of the fuselage main body.

The first drive motor and the second drive motor are electrically connected with the control module respectively.

The control module is used to control the first drive motor to be initiated to drive the first drive propeller to start to rotate, so as to drive the unmanned aerial vehicle to fly forward; and/or,

the control module is used to control the second drive motor to be initiated to drive the second drive propeller to start to rotate, so as to push the unmanned aerial vehicle to fly forward.

Preferably, the control module is used to control, when the first drive motor fails, the second drive motor to be initiated to drive the second drive propeller to start to rotate, so as to push the unmanned aerial vehicle to fly forward; or,

the control module is used to control, when the second drive motor fails, the first drive motor to be initiated to drive the first drive propeller to start to rotate, so as to drive the unmanned aerial vehicle to fly forward.

Preferably, the unmanned aerial vehicle further includes a third steering engine and two vertical tails.

The two vertical tails are provided on two sides of a vertical direction of the tail end of the fuselage main body respectively.

At least one third steering engine is provided in each vertical tail.

Each third steering engine is fixedly connected with one third control surface on the vertical tail.

The third steering engines are electrically connected with the control module.

The control module is used to control the third steering engines to adjust the deflecting directions of the third control surfaces.

Preferably, when one third steering engine is provided on each vertical tail, the control module is used to control, when one third steering engine fails, the other third steering engine to adjust the deflecting direction of the corresponding third control surface.

Preferably, the unmanned aerial vehicle further includes at least two airspeed tubes.

The airspeed tubes are respectively provided on the fuselage main body and/or the motor arms.

The orientations of the airspeed tubes are consistent with the flight direction of the unmanned aerial vehicle.

Preferably, when two ends of the motor arms are respectively provided with two lift motors, each lift motor is fixedly connected with one lift propeller.

When the unmanned aerial vehicle includes two airspeed tubes, each airspeed tube is fixedly provided at the front end position of one motor arm.

The present invention further provides a control method for an unmanned aerial vehicle. The control method is applied in the above unmanned aerial vehicle, and includes:

presetting, by the control module, a correspondence between two ends of each motor arm and the corresponding lift motors;

controlling, by the control module, each lift motor to be initiated to drive the corresponding lift propeller to rotate to work;

determining, by the control module, whether a lift motor fails, determining that the failing lift motor is a target lift motor if so, acquiring, according to the correspondence, a target position on the motor arm corresponding to the target lift motor, and adjusting the power of other lift motors in all the lift motors corresponding to the target position apart from the target lift motor.

Preferably, when the aerial vehicle further includes at least two first steering engines and second steering engines, the first steering engines are fixedly provided in a left wing of the aerial vehicle, the second steering engines are fixedly provided in a right wing of the aerial vehicle, each first steering engine is fixedly connected with one first control surface on the left wing, and each second steering engine is fixedly connected with one second control surface on the right wing, the control method further includes:

controlling, by the control module, the first steering engines and the second steering engines to adjust the deflecting directions of the first control surfaces and the second control surfaces.

Preferably, when the left wing includes two first steering engines, the first steering engines include a first sub steering engine and a second sub steering engine, and the second sub steering engine is located on the outer side of the first sub steering engine; when the left wing includes two second steering engines, the second steering engines include a third sub steering engine and a fourth sub steering engine, and the fourth sub steering engine is located on the outer side of the third sub steering engine; the control method further includes:

controlling, by the control module, the deflecting directions of both the first control surface corresponding to the first sub steering engine and the second control surface corresponding to the third sub steering engine to be upward, and controlling, by the control module, the deflecting directions of both the first control surface corresponding to the second sub steering engine and the second control surface corresponding to the fourth sub steering engine to be downward.

Preferably, when the two first steering engines are provided in the left wing, and the two second steering engines are provided in the right wing, the control method further includes:

controlling, by the control module, the corresponding deflecting directions of the two first control surfaces of the left wing to be opposite, and controlling, by the control module, the corresponding deflecting directions of the two second control surfaces of the right wing to be opposite; or, control, by the control module, the deflecting directions of the two first steering engines and the two second steering engines to be consistent.

Preferably, when the aerial vehicle further includes a first drive motor, a second drive motor, a first drive propeller and a second drive propeller, the control method further includes:

controlling, by the control module, the first drive motor to be initiated to drive the first drive propeller to start to rotate, so as to drive the aerial vehicle to fly forward; and/or,

controlling, by the control module, the second drive motor to be initiated to drive the second drive propeller to start to rotate, so as to push the aerial vehicle to fly forward.

Preferably, the control method further includes:

when the first drive motor fails, controlling, by the control module, the second drive motor to be initiated to drive the second drive propeller to start to rotate, so as to push the aerial vehicle to fly forward; or,

when the second drive motor fails, controlling, by the control module, the first drive motor to be initiated to drive the first drive propeller to start to rotate, so as to drive the aerial vehicle to fly forward.

Preferably, when the aerial vehicle further includes third steering engines and two vertical tails, the control method further includes:

controlling, by the control module, the third steering engines to adjust the deflecting directions of the third control surfaces.

Preferably, when one third steering engine is provided on each vertical tail, the control method further includes:

when one third steering engine fails, controlling, by the control module, the other third steering engine to adjust the deflecting direction of the corresponding third control surface.

The present invention has positive progressive results:

1) the lift motors and the lift propellers are respectively added at four positions on the motor arms, and are simultaneously initiated, so that the stability of the aerial vehicle is improved; when one lift motor at a certain position fails, the power of other lift motors corresponding to this position is adjusted to improve the safety of the aerial vehicle;

2) the steering engines are added at the left and right wings, so as to improve the accuracy of flight angle control for the aerial vehicle; the steering engines close to the fuselage main body can be controlled to adjust the deflecting directions of the control surfaces, thereby increasing the lift force of the aerial vehicle; by setting the deflecting directions of the control surfaces of the same pair of wings to be opposite, the objective of using the wings as spoilers is achieved; in addition, when one control surface loses the effect, other control surfaces still keep working, thus ensuring the safety of the aerial vehicle;

3) by providing the front pulling and back pushing drive motors to guarantee sufficient power during the cruise of the aerial vehicle, the stability of the aerial vehicle is ensured, and the cooperative use of the two drive motors also improves the safety of the aerial vehicle at the same time;

4) the vertical tails of longitudinally symmetrical structures are provided, and the steering engines are provided on both the vertical tails, so that the control surface efficiency and the servo torque conduction are ensured, and the safety of the aerial vehicle is improved at the same time;

5) the airspeed tubes are added on both the left and right sides of the front end of the aerial vehicle, so that the accuracy of existing airspeed data is improved, and the air safety control for the aerial vehicle is further ensured.

### BRIEF DESCRIPTION OF THE DRAWINGS

FIG. 1 is a schematic structural diagram of an unmanned aerial vehicle of Embodiment 1 of the present invention.

FIG. 2 is a schematic structural diagram of a first visual angle of an unmanned aerial vehicle of Embodiment 1 of the present invention.

FIG. 3 is a schematic structural diagram of a second visual angle of an unmanned aerial vehicle of Embodiment 1 of the present invention.

FIG. 4 is a schematic structural diagram of an unmanned aerial vehicle of Embodiment 2 of the present invention.

FIG. 5 is a schematic structural diagram of a first visual angle of an unmanned aerial vehicle of Embodiment 2 of the present invention.

FIG. 6 is a schematic structural diagram of a second visual angle of an unmanned aerial vehicle of Embodiment 2 of the present invention.

FIG. 7 is a schematic structural diagram of a third visual angle of an unmanned aerial vehicle of Embodiment 2 of the present invention.

FIG. 8 is a flowchart of a control method for an unmanned aerial vehicle of Embodiment 3 of the present invention.

### DESCRIPTION OF THE EMBODIMENTS

The present invention will be further described below in a manner of embodiments, but the present invention is not limited to the scope of the embodiments accordingly.

### Embodiment 1

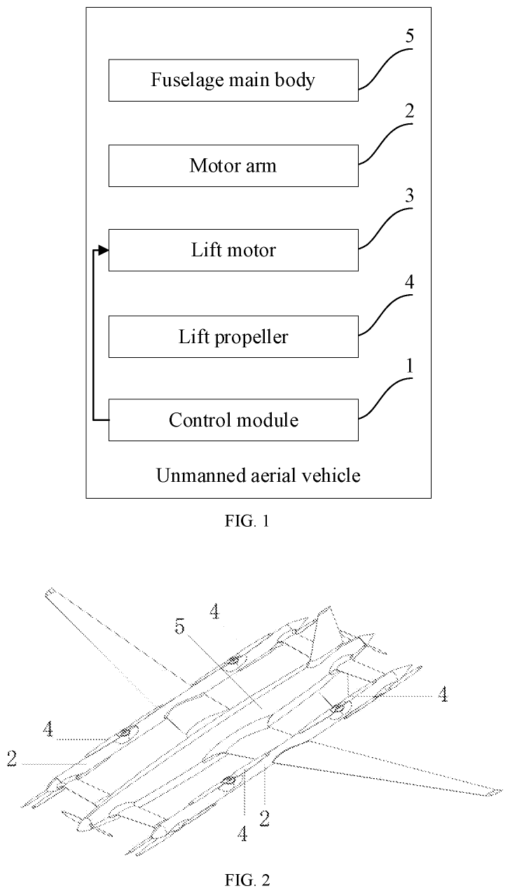

As shown in FIG. 1, an unmanned aerial vehicle of the present embodiment includes a control module 1, motor arms 2, a plurality of lift motors 3 and lift propellers 4.

The control module 1 is provided in a fuselage main body 5 of the unmanned aerial vehicle. The motor arms 2 are fixedly provided on two sides of the fuselage main body 5 in parallel respectively. The lift motors 3 are electrically connected with the control module 1.

Two ends of the motor arms 2 are respectively provided with at least two lift motors 3. The lift motors 3 are provided in the motor arms 2. One lift motor 3 is fixedly connected with at least one lift propeller 4.

The control module 1 is used to preset a correspondence between two ends of each motor arm 2 and the corresponding lift motors 3. Preferably, the number of lift motors corresponding to each end of each motor arm is equal.

The control module 1 is used to control each lift motor 3 to be initiated to drive the corresponding lift propeller 4 to rotate to work.

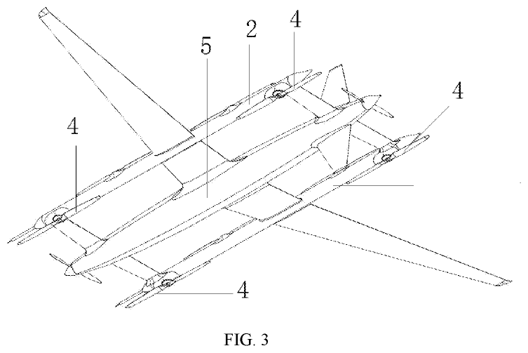

Specifically, as shown in FIG. 2 and FIG. 3, when two ends of the motor arms 2 are respectively provided with two lift motors 3, each lift motor 3 is fixedly connected with one lift propeller 4; and at this time, the aerial vehicle includes two motor arms; one end of each motor arm is correspondingly provided with two lift motors and corresponding lift propellers, totally including 8 lift motors and 8 lift propellers. In the cruise process of the aerial vehicle, the 8 lift motors are controlled to be simultaneously initiated to work, thereby guaranteeing the stability of the aerial vehicle.

The control module 1 is also used to determine whether a lift motor 3 fails, determine that the failing lift motor 3 is a target lift motor 3 if so, acquire, according to the correspondence, a target position on the motor arm 2 corresponding to the target lift motor 3, and adjust the power of other lift motors 3 in all the lift motors 3 corresponding to the target position apart from the target lift motor 3.

Specifically, the power of each of the residual lift motors corresponding to the target position can be controlled to increase the same power, or only the power of partial lift motors is increased, thereby effectively avoiding such a phenomenon of crash and damage of the whole aerial vehicle caused by the fact that one lift motor loses the lift effect.

In the present embodiment, the lift motors and the lift propellers are respectively added at four positions on the motor arms, and are simultaneously initiated, so that the stability of the aerial vehicle is improved; when one lift motor at a certain position fails, the power of other lift motors corresponding to this position is adjusted to improve the safety of the aerial vehicle.

### Embodiment 2

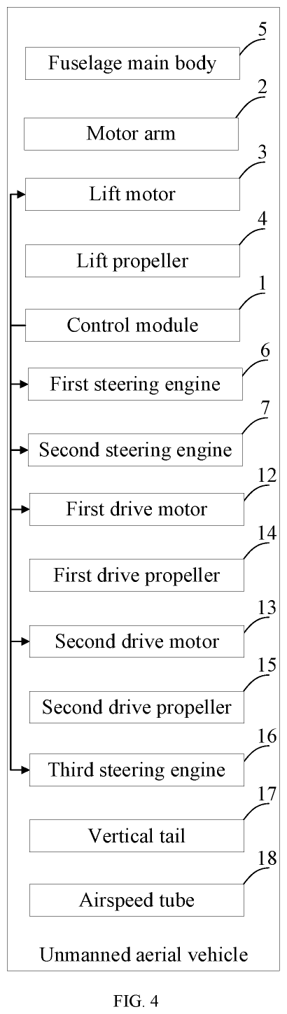

As shown in FIG. 4, the aerial vehicle of the present embodiment is a further improvement on Embodiment 1.

The aerial vehicle of the present embodiment further includes at least two first steering engines 6 and second steering engines 7.

The first steering engines 6 are fixedly provided in a left wing of the aerial vehicle, and the second steering engines 7 are fixedly provided in a right wing of the aerial vehicle.

Each first steering engine 6 is fixedly connected with one first control surface on the left wing, and each second steering engine 7 is fixedly connected with one second control surface on the right wing.

The control module 1 is electrically connected with the first steering engines 6 and the second steering engines 7.

The control module 1 is used to control the first steering engines 6 and the second steering engines 7 to adjust the deflecting directions of the first control surfaces and the second control surfaces.

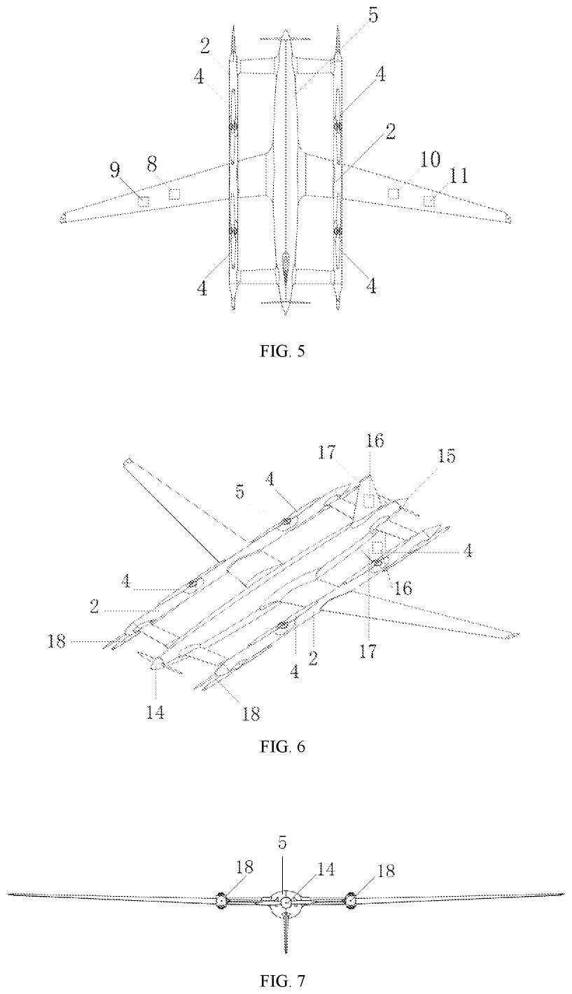

Specifically, as shown in FIG. 5, when the left wing includes two first steering engines 6, the first steering engines 6 include a first sub steering engine 8 and a second sub steering engine 9, and the second sub steering engine 9 is located on the outer side of the first sub steering engine 8. When the left wing includes two second steering engines 7, the second steering engines 7 include a third sub steering engine 10 and a fourth sub steering engine 11, and the fourth sub steering engine 11 is located on the outer side of the third sub steering engine 10.

The control module 1 is used to control the deflecting directions of both the first control surface corresponding to the first sub steering engine 8 and the second control surface corresponding to the third sub steering engine 10 to be upward, and control the deflecting directions of both the first control surface corresponding to the second sub steering engine 9 and the second control surface corresponding to the fourth sub steering engine 11 to be downward, so as to increase the lift force of the aerial vehicle and improve the flight performance of the aerial vehicle.

When the two first steering engines 6 are provided in the left wing, and the two second steering engines 7 are provided in the right wing, the control module 1 is used to control the corresponding deflecting directions of the two first control surfaces of the left wing to be opposite, and control the corresponding deflecting directions of the two second control surfaces of the right wing to be opposite; and at this time, this is equivalent to a function of spoilers.

When the two first steering engines 6 are provided in the left wing, and the two second steering engines 7 are provided in the right wing, the control module 1 is used to control the deflecting directions of the two first steering engines 6 and the two second steering engines 7 to be consistent; and at this time, if one steering engine fails, other steering engines still keep working, thereby ensuring that the safety of the aerial vehicle cannot be affected.

As shown in FIG. 4 and FIG. 6, the aerial vehicle of the present embodiment further includes a first drive motor 12, a second drive motor 13, a first drive propeller 14 and a second drive propeller 15.

Both the first drive motor 12 and the second drive motor 13 are provided in the fuselage main body 5, and are fixedly provided at the front end and the rear end of the fuselage main body 5 respectively.

The first drive propeller 14 is electrically connected with the first drive motor 12, and the first drive propeller 14 is fixedly provided at the front end of the fuselage main body 5. The second drive propeller 15 is electrically connected with the second drive motor 13, and the second drive propeller 15 is fixedly provided at the rear end of the fuselage main body 5. The first drive motor 12 and the second drive motor 13 are electrically connected with the control module 1 respectively.

The control module 1 is used to control the first drive motor 12 to be initiated to drive the first drive propeller 14 to start to rotate, so as to drive the aerial vehicle to fly forward; and/or,

the control module 1 is used to control the second drive motor 13 to be initiated to drive the second drive propeller 15 to start to rotate, so as to push the aerial vehicle to fly forward. That is, one single drive motor can be used to drive or push the aerial vehicle, and two drive manners can also be used and combined to better ensure the flight dynamics and safety of the aerial vehicle.

The control module 1 is used to control, when the first drive motor 12 fails, the second drive motor 13 to be initiated to drive the second drive propeller 15 to start to rotate, so as to push the aerial vehicle to fly forward; or,

the control module 1 is used to control, when the second drive motor 13 fails, the first drive motor 12 to be initiated to drive the first drive propeller 14 to start to rotate, so as to drive the aerial vehicle to fly forward. That is, when a certain drive manner loses the effect, the other drive manner is used immediately to keep drive control, and then the flight safety of the aerial vehicle is guaranteed, so that the safety of the whole aerial vehicle is ensured.

As shown in FIG. 4, the aerial vehicle of the present embodiment further includes third steering engines 16 and two vertical tails 17.

The two vertical tails 17 are provided on two sides of a vertical direction of the tail end of the fuselage main body 5 respectively.

At least one third steering engine 16 is provided in each vertical tail 17.

Each third steering engine 16 is fixedly connected with one third control surface on the vertical tail 17.

The third steering engines 16 are electrically connected with the control module 1.

The control module 1 is used to control the third steering engines 16 to adjust the deflecting directions of the third control surfaces.

As shown in FIG. 6, when one third steering engine 16 is provided on each vertical tail 17, the control module 1 is used to control, when one third steering engine 16 fails, the other third steering engine 16 to adjust the deflecting direction of the corresponding third control surface, so that the safety of the whole aerial vehicle is further guaranteed.

As shown in FIG. 4, the aerial vehicle of the present embodiment further includes at least two airspeed tubes 18.

The airspeed tubes 18 are respectively provided on the fuselage main body 5 and/or the motor arms 2.

The orientations of the airspeed tubes 18 are consistent with the flight direction of the aerial vehicle. The airspeed tubes 18 are electrically connected with the control module 1.

As shown in FIG. 6 and FIG. 7, when the aerial vehicle includes two airspeed tubes 18, each airspeed tube 18 is fixedly provided at the front end position of one motor arm 2.

The airspeed tubes are added on both the left and right sides of the front end of the aerial vehicle, so that the interference of other structures is avoided; and furthermore, an airspeed corresponding to the unmanned aerial vehicle is finally determined by means of a plurality of pieces of airspeed data, so that the accuracy of the existing airspeed data is improved, and the flight safety control for the aerial vehicle is further ensured.

In the present embodiment, by respectively adding the lift motors and the lift propellers at the four positions of the motor arms, adding the steering engines on the left and right wings, providing the front pulling and back pushing drive motors, providing the vertical tails of the longitudinally symmetrical structures and adding the airspeed tubes on both the left and right sides of the front end of the aerial vehicle, the stability and the safety of the aerial vehicle are effectively improved.

### Embodiment 3

A control method for an unmanned aerial vehicle of the present embodiment is implemented in the unmanned aerial vehicle of any one of Embodiment 1 or Embodiment 2.

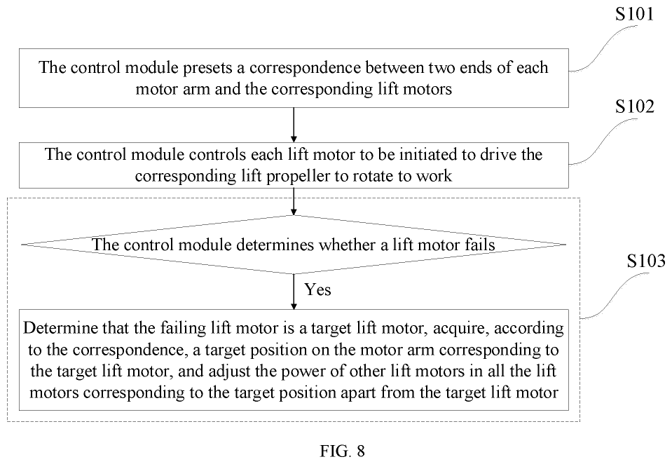

As shown in FIG. 8, the control method of the present embodiment includes that:

S101, the control module presets a correspondence between two ends of each motor arm and the corresponding lift motors.

Preferably, the number of lift motors corresponding to each end of each motor arm is equal.

S102, the control module controls each lift motor to be initiated to drive the corresponding lift propeller to rotate to work.

Specifically, as shown in FIG. 2, when two ends of the motor arms are respectively provided with two lift motors, each lift motor is fixedly connected with one lift propeller; and at this time, the aerial vehicle includes two motor arms; one end of each motor arm is correspondingly provided with two lift motors and corresponding lift propellers, totally including 8 lift motors and 8 lift propellers. In the cruise process of the aerial vehicle, the 8 lift motors are controlled to be simultaneously initiated to work, thereby guaranteeing the stability of the aerial vehicle.

S103, the control module determines whether a lift motor fails, determines that the failing lift motor is a target lift motor if so, acquires, according to the correspondence, a target position on the motor arm corresponding to the target lift motor, and adjusts the power of other lift motors in all the lift motors corresponding to the target position apart from the target lift motor.

Specifically, the power of each of the residual lift motors corresponding to the target position can be controlled to increase the same power, or only the power of partial lift motors is increased, thereby effectively avoiding such a phenomenon of crash and damage of the whole aerial vehicle caused by the fact that one lift motor loses the lift effect.

In the present embodiment, by means of the lift motors and the lift propellers which are added on the motor arms to perform flight control, the stability of the aerial vehicle is improved; and when one lift motor at a certain position fails, the power of other lift motors corresponding to this position is adjusted immediately, so that the safety of the aerial vehicle is improved.

### Embodiment 4

A control method for an unmanned aerial vehicle of the present embodiment is a further improvement on Embodiment 3. Specifically:

when the unmanned aerial vehicle further includes at least two first steering engines and second steering engines, the first steering engines are fixedly provided in a left wing of the aerial vehicle, the second steering engines are fixedly provided in a right wing of the aerial vehicle, each first steering engine is fixedly connected with one first control surface on the left wing, and each second steering engine is fixedly connected with one second control surface on the right wing, the control method further includes that:

S104, the control module controls the first steering engines and the second steering engines to adjust the deflecting directions of the first control surfaces and the second control surfaces.

When the left wing includes two first steering engines, the first steering engines include a first sub steering engine and a second sub steering engine, and the second sub steering engine is located on the outer side of the first sub steering engine;

when the left wing includes two second steering engines, the second steering engines include a third sub steering engine and a fourth sub steering engine, and the fourth sub steering engine is located on the outer side of the third sub steering engine; the step S104 specifically includes that:

S1041, the control module controls the deflecting directions of both the first control surface corresponding to the first sub steering engine and the second control surface corresponding to the third sub steering engine to be upward, and controls the deflecting directions of both the first control surface corresponding to the second sub steering engine and the second control surface corresponding to the fourth sub steering engine to be downward, so as to increase the lift force of the aerial vehicle and improve the flight performance of the aerial vehicle.

When the two first steering engines are provided in the left wing, and the two second steering engines are provided in the right wing, the step S104 specifically includes that:

S1042, the control module controls the corresponding deflecting directions of the two first control surfaces of the left wing to be opposite, and controls the corresponding deflecting directions of the two second control surfaces of the right wing to be opposite; and at this time, this is equivalent to a function of spoilers.

When the two first steering engines are provided in the left wing, and the two second steering engines are provided in the right wing, the step S104 specifically includes that:

S1043, the control module controls the deflecting directions of the two first steering engines and the two second steering engines to be consistent; and at this time, if one steering engine fails, other steering engines still keep working, thereby ensuring that the safety of the aerial vehicle cannot be affected.

When the aerial vehicle further includes a first drive motor, a second drive motor, a first drive propeller and a second drive propeller, the control method of the present embodiment further includes that:

S105, the control module controls the first drive motor to be initiated to drive the first drive propeller to start to rotate, so as to drive the aerial vehicle to fly forward; and/or,

the control module controls the second drive motor to be initiated to drive the second drive propeller to start to rotate, so as to push the aerial vehicle to fly forward. That is, one single drive motor can be used to drive or push the aerial vehicle, and two drive manners can also be used and combined to better ensure the flight dynamics and safety of the aerial vehicle.

Specifically, the step S105 includes that:

the control module controls, when the first drive motor fails, the second drive motor to be initiated to drive the second drive propeller to start to rotate, so as to push the aerial vehicle to fly forward; or,

the control module controls, when the second drive motor fails, the first drive motor to be initiated to drive the first drive propeller to start to rotate, so as to drive the aerial vehicle to fly forward. That is, when a certain drive manner loses the effect, the other drive manner is used immediately to keep drive control, and then the flight safety of the aerial vehicle is guaranteed, so that the safety of the whole aerial vehicle is ensured.

When the aerial vehicle further includes third steering engines and two vertical tails, as shown in FIG. 13, the control method of the present invention further includes that:

S106, the control module controls the third steering engines to adjust the deflecting directions of the third control surfaces.

When one third steering engine is provided on each vertical tail, the step S106 includes that:

the control module controls, when one third steering engine fails and the aerial vehicle includes two motor arms, the other third steering engine to adjust the deflecting direction of the corresponding third control surface, so that the safety of the whole aerial vehicle is further ensured.

When the aerial vehicle includes two airspeed tubes, each airspeed tube is fixedly provided at the front end position of one motor arm. The airspeed tubes are added on both the left and right sides of the front end of the aerial vehicle, so that the interference of other structures is avoided; and furthermore, an airspeed corresponding to the unmanned aerial vehicle is finally determined by means of a plurality of pieces of airspeed data, so that the accuracy of the existing airspeed data is improved, and the flight safety control for the aerial vehicle is further ensured.

In the present embodiment, by means of the lift motors and the lift propellers which are added at the four positions of the motor arms, the steering engines added on the left and right wings, the front pulling and back pushing drive motors provided at the front end and the rear end of the fuselage main body, the added vertical tails of the longitudinally symmetrical structures and the airspeed tubes added on both the left and right sides of the front end of the aerial vehicle, the stability and the safety of the aerial vehicle are effectively improved.

Although the specific implementation modes of the present invention have been described above, those skilled in the art should understand that this is only an example, and the protection scope of the present invention is defined by the appended claims. Those skilled in the art can make various changes or modifications to these implementations without departing from the principle and essence of the present invention, but these changes and modifications shall all fall within the protection scope of the present invention.

What is claimed is:

1. An unmanned aerial vehicle, comprising a control module, motor arms, a plurality of lift motors and lift propellers, wherein
the control module is provided in a fuselage main body of the unmanned aerial vehicle;
the motor arms are fixedly provided on two sides of the fuselage main body in parallel respectively;
the lift motors are electrically connected with the control module;
two ends of the motor arms are respectively provided with at least two of the lift motors;
the lift motors are provided in the motor arms, and the lift propellers are fixedly provided on the motor arms;
one lift motor is fixedly connected with at least one lift propeller;
the control module is used to preset a correspondence between two ends of each motor arm and the corresponding lift motors;
the control module is used to control each lift motor to be initiated to drive the corresponding lift propeller to rotate to work;
the control module is also used to determine whether a lift motor fails, determine that the failing lift motor is a target lift motor if so, acquire, according to the correspondence, a target position on the motor arm corresponding to the target lift motor, and adjust the power of other lift motors in all the lift motors corresponding to the target position apart from the target lift motor.

2. The unmanned aerial vehicle according to claim 1, further comprising at least two first steering engines and second steering engines, wherein
the first steering engines are fixedly provided in a left wing of the unmanned aerial vehicle, and the second steering engines are fixedly provided in a right wing of the unmanned aerial vehicle;
each first steering engine is fixedly connected with one first control surface on the left wing, and each second steering engine is fixedly connected with one second control surface on the right wing;
the control module is electrically connected with the first steering engines and the second steering engines respectively;
the control module is used to control the first steering engines and the second steering engines to adjust the deflecting directions of the first control surfaces and the second control surfaces.

3. The unmanned aerial vehicle according to claim 2, wherein when the left wing comprises two first steering engines, the first steering engines comprise a first sub steering engine and a second sub steering engine, and the second sub steering engine is located on the outer side of the first sub steering engine;
when the left wing comprises two second steering engines, the second steering engines comprise a third sub steering engine and a fourth sub steering engine, and the fourth sub steering engine is located on the outer side of the third sub steering engine;
the control module is used to control the deflecting directions of both the first control surface corresponding to the first sub steering engine and the second control surface corresponding to the third sub steering engine to be upward, and control the deflecting directions of both the first control surface corresponding to the second sub steering engine and the second control surface corresponding to the fourth sub steering engine to be downward.

4. The unmanned aerial vehicle according to claim 2, wherein when two first steering engines are provided in the left wing, and two second steering engines are provided in the right wing, the control module is used to control the deflecting directions corresponding to the two first control surfaces of the left wing to be opposite, and control the deflecting directions corresponding to the two second control surfaces of the right wing to be opposite; or, the control module is used to control the deflecting directions of the two first steering engines and the two second steering engines to be consistent.

5. The unmanned aerial vehicle according to claim 1, further comprising a first drive motor, a second drive motor, a first drive propeller and a second drive propeller,
wherein both the first drive motor and the second drive motor are provided in the fuselage main body, and are fixedly provided at the front end and the rear end of the fuselage main body respectively;
the first drive propeller is electrically connected with the first drive motor, and the first drive propeller is fixedly provided at the front end of the fuselage main body;
the second drive propeller is electrically connected with the second drive motor, and the second drive propeller is fixedly provided at the rear end of the fuselage main body;
the first drive motor and the second drive motor are electrically connected with the control module respectively;
the control module is used to control the first drive motor to be initiated to drive the first drive propeller to start to rotate, so as to drive the unmanned aerial vehicle to fly forward; and/or,
the control module is used to control the second drive motor to be initiated to drive the second drive propeller to start to rotate, so as to push the unmanned aerial vehicle to fly forward.

6. The unmanned aerial vehicle according to claim 5, wherein the control module is used to control, when the first drive motor fails, the second drive motor to be initiated to drive the second drive propeller to start to rotate, so as to push the unmanned aerial vehicle to fly forward; or,
the control module is used to control, when the second drive motor fails, the first drive motor to be initiated to drive the first drive propeller to start to rotate, so as to drive the unmanned aerial vehicle to fly forward.

7. The unmanned aerial vehicle according to claim 1, further comprising third steering engines and two vertical tails,
wherein the two vertical tails are provided on two sides of a vertical direction of the tail end of the fuselage main body respectively;
at least one third steering engine is provided in each vertical tail;
each third steering engine is fixedly connected with one third control surface on the vertical tail;
the third steering engines are electrically connected with the control module;
the control module is used to control the third steering engines to adjust the deflecting directions of the third control surfaces.

8. The unmanned aerial vehicle according to claim 7, wherein when one third steering engine is provided on each vertical tail, the control module is used to control, when one third steering engine fails, the other third steering engine to adjust the deflecting direction of the corresponding third control surface.

9. The unmanned aerial vehicle according to claim 1, further comprising at least two airspeed tubes,
wherein the airspeed tubes are respectively provided on the fuselage main body and/or the motor arms;
the orientations of the airspeed tubes are consistent with the flight direction of the unmanned aerial vehicle.

10. The unmanned aerial vehicle according to claim 9, wherein when two ends of the motor arms are respectively provided with two lift motors, each lift motor is fixedly connected with one lift propeller;
when the unmanned aerial vehicle comprises two airspeed tubes, each airspeed tube is fixedly provided at the front end position of one motor arm.

11. A control method for an unmanned aerial vehicle, which is applied to the unmanned aerial vehicle according to claim 1, wherein the control method comprises:
presetting, by the control module, a correspondence between two ends of each motor arm and the corresponding lift motors;
controlling, by the control module, each lift motor to be initiated to drive the corresponding lift propeller to rotate to work;
determining, by the control module, whether a lift motor fails, determining that the failing lift motor is a target lift motor if so, acquiring, according to the correspondence, a target position on the motor arm corresponding to the target lift motor, and adjusting the power of other lift motors in all the lift motors corresponding to the target position apart from the target lift motor.

12. The control method for the unmanned aerial vehicle according to claim 11, wherein when the aerial vehicle further comprises at least two first steering engines and second steering engines, the first steering engines are fixedly provided in a left wing of the aerial vehicle, the second steering engines are fixedly provided in a right wing of the aerial vehicle, each first steering engine is fixedly connected with one first control surface on the left wing, and each second steering engine is fixedly connected with one second control surface on the right wing, the control method further comprises:
controlling, by the control module, the first steering engines and the second steering engines to adjust the deflecting directions of the first control surfaces and the second control surfaces.

13. The control method for the unmanned aerial vehicle according to claim 12, wherein when the left wing comprises two first steering engines, the first steering engines comprise a first sub steering engine and a second sub steering engine, and the second sub steering engine is located on the outer side of the first sub steering engine; when the left wing comprises two second steering engines, the second steering engines comprise a third sub steering engine and a fourth sub steering engine, and the fourth sub steering engine is located on the outer side of the third sub steering engine; the control method further comprises:
controlling, by the control module, the deflecting directions of both the first control surface corresponding to the first sub steering engine and the second control surface corresponding to the third sub steering engine to be upward, and controlling, by the control module, the deflecting directions of both the first control surface corresponding to the second sub steering engine and the second control surface corresponding to the fourth sub steering engine to be downward.

14. The control method for the unmanned aerial vehicle according to claim 12, wherein when two first steering engines are provided in the left wing, and two second steering engines are provided in the right wing, the control method further comprises:
controlling, by the control module, the corresponding deflecting directions of the two first control surfaces of the left wing to be opposite, and controlling, by the control module, the corresponding deflecting directions of the two second control surfaces of the right wing to be opposite; or, control, by the control module, the deflecting directions of the two first steering engines and the two second steering engines to be consistent.

15. The control method for the unmanned aerial vehicle according to claim 11, wherein when the aerial vehicle further comprises a first drive motor, a second drive motor, a first drive propeller and a second drive propeller, the control method further comprises:
controlling, by the control module, the first drive motor to be initiated to drive the first drive propeller to start to rotate, so as to drive the aerial vehicle to fly forward; and/or,
controlling, by the control module, the second drive motor to be initiated to drive the second drive propeller to start to rotate, so as to push the aerial vehicle to fly forward.

16. The control method for the unmanned aerial vehicle according to claim 15, further comprising:
when the first drive motor fails, controlling, by the control module, the second drive motor to be initiated to drive the second drive propeller to start to rotate, so as to push the aerial vehicle to fly forward; or,
when the second drive motor fails, controlling, by the control module, the first drive motor to be initiated to drive the first drive propeller to start to rotate, so as to drive the aerial vehicle to fly forward.

17. The control method for the unmanned aerial vehicle according to claim 11, wherein when the aerial vehicle further comprises third steering engines and two vertical tails, the control method further comprises:
controlling, by the control module, the third steering engines to adjust the deflecting directions of the third control surfaces.

18. The control method for the unmanned aerial vehicle according to claim 17, wherein when one third steering engine is provided on each vertical tail, the control method further comprises:
when one third steering engine fails, controlling, by the control module, the other third steering engine to adjust the deflecting direction of the corresponding third control surface.
